(19) United States
(12) Patent Application Publication
(10) Pub. No.: US 2013/0149418 A1
(43) Pub. Date: Jun. 13, 2013

(54) Edible Gift-Wrap for Pets

(71) Applicant: Susan Lea Carlson, Omaha, NE (US)

(72) Inventor: Susan Lea Carlson, Omaha, NE (US)

(21) Appl. No.: 13/710,045

(22) Filed: Dec. 10, 2012

Related U.S. Application Data
(60) Provisional application No. 61/568,723, filed on Dec. 9, 2011.

(51) Int. Cl. A23K 1/10

(52) U.S. Cl. 426/140; 426/138; 426/390

(57) ABSTRACT

An edible gift-wrap system for pets is provided. The system includes an edible gift box made from a heavy weight edible paper and a sheet of gift-wrap made from a lightweight edible paper. Optional components include a lid and decorative items such as bows or stickers. Each component of the system will come in a variety of flavors and will be composed of materials that are digestible and safe for consumption by particular species/breeds of pets. Patterns and photos may be printed on the box and paper using edible inks, in order to create an attractive presentation. Pet owners will be able to mentally and physically stimulate their pet by providing an edible puzzle that the pet must chew through in order to reach the hidden gift surprise. In this way the system gives pets a varied chewing experience in both texture and flavor.

### CROSS REFERENCE TO RELATED APPLICATION

This application claims the benefit of U.S. Provisional Application No. 61/568,723 filed on Dec. 9, 2011, entitled “Pet-Edible Giftwrap.” For the purposes of presenting a clear and continuous disclosure, the aforementioned application is incorporated herein by reference.

### BACKGROUND OF THE INVENTION

1. Field of the Invention

The present invention relates to novelty pet treats. More specifically, it relates to a pet gift-wrap set including a rigid container and a thin, flexible paper and a method of making the paper. Both items contain animal meat and/or hide to present a tasty treat for dogs, or other omnivorous pets. Treats can be placed within the container and paper, which are “opened” by a chewing pet.

Domestic pets and farm animals are increasingly treated as members of a family rather than workers. In the past, dogs and cats, chickens and rabbits were viewed as having primarily utilitarian roles in the daily lives of human families. Dogs protect the home, cats catch rodents, and chickens and other birds control the insect population. Farm animals, such as horses, cows and goats were even further removed from the home, and were thus thought of as farm workers rather than domestic animals. Today, many people see their animal companions as friends and family members. Animals are now an important part of the emotional health of the household in addition to serving helpful roles.

Many people enjoy including their non-human family members in festivities, such as birthdays, Christmas, and Halloween. Pets of all varieties are given gifts on holidays. Edible treats, squeaky toys, stuffed animals, snuggly blankets and the like, are common gifts for animal companions. Presenting pets with a safe, edible and attractive gift-wrap is a common problem for most pet owners. Conventional wrapping papers and gift boxes are not suitable because pets lack the opposable thumbs needed to open the package. Pets are thus obliged to chew their way through the paper to reach their gift. This is problematic because most conventional papers and gift boxes are not safe for consumption, and are not digestible. A system for wrapping pet gifts is needed that is edible, non-toxic and entirely digestible.

2. Description of the Prior Art

The present invention is an edible gift-wrap system for pets and a method of making edible gift paper. A heavyweight edible paper container is provided, and a flexible sheet of flavored paper is used to wrap pet treats and toys. Wrapping pet gifts in this way provides a means for pets to safely “open” their own gifts by chewing through the tasty container and paper. The system thus provides two textures of pet treats that are used to enclose other pet toys or treats. The prior art discloses paper that is safe for pets to ingest, but does not disclose a pet gift-wrapping system that includes a variety of treat textures.

Edible papers are used to make a variety of pet treats. Greeting cards for pets are disclosed in Hov, U.S. Patent Application Publication No. 2005/0106289 that are made from a gluten paper and are safe for animal consumption. The edible paper may be made from a variety of ingredients formed into a rigid cardstock. Designs and decorations are added to the cardstock in accordance with a particular greeting or holiday. Several of the cardstock pieces are joined together to form a booklet, or are formed into a structured shape such as a dog or cat. Hov thus provides an edible greeting card that can be given to pets as a treat. Hov does not disclose a rigid container, nor does it disclose a flexible paper product that can be used to wrap animal treats. The present invention provides both a container and a flexible paper so that pets will experience a variety of texture and taste sensations while opening their gifts.

Flexible edible paper can be used to wrap gifts, as in the present invention. Such wrapping paper is used to surround and conceal an object, preferably a non-toxic item, until the recipient eats through the paper. Hyttel, U.S. Patent Application Publication No. 2009/0249751 discloses an edible wrapping paper that is suitable for human consumption. The wrapping paper is made from rice or wafer paper and may be scented or flavored. An envelope adhesive is used to adhere parts of the paper together during the wrapping process. Unlike the present invention, Hyttel does not teach a container or the use of meat products in the paper. The present invention is both a container for holding treats and a wrapping paper, or tissue paper that is used in conjunction with the container.

A flexible adhesive sticker made from edible paper is disclosed by Moulton, U.S. Patent Application Publication No. 2005/0170040. The stickers are made from an edible rice paper infused with catnip oil or a dried pulverized catnip infusion, and coated with a non-toxic, digestible adhesive. Individual stickers are made in a variety of shapes and colors. They may be placed on treats, toys, or other objects to attract the pet to the item. Moulton does not disclose a container, or a flexible sheet of paper. The present invention discloses both of these features and is thus better adapted to wrapping pet gifts than the rice paper stickers of Moulton.

Edible films may be used in lieu of paper for adhering images to a pet treat. Otto, U.S. Patent Application publication No. 2009/0088629 discloses a pet treat made from a baked biscuit/cookie and an edible polymer film. The film is the same as those used in human oral thinfilms and is saliva soluble. Food coloring is used to print customized pictures on the film, such as images of the pet, the pet's name, advertising logos, and the like. After an image is printed on the film, the film is adhered to the pet cookie/biscuit to create a customized, edible pet snack. Though Otto does disclose a flexible film that can be used to wrap treats, the film is water soluble and could dissolve prior to consumption by the pet. Edible films are made from chemical created polymers and should not be consumed by animals in large quantities.

These prior art devices have several known drawbacks. They fail to disclose an all-natural wrapping paper suitable for consumption by pets and an accompanying rigid container made of all-natural edible materials. The present invention provides both of these elements so that pets will engage in a dynamic chewing experience as they open gifts. It substantially diverges in design elements from the prior art and consequently it is clear that there is a need in the art for an improvement to existing edible wrapping paper for pets. In this regard the instant invention substantially fulfills these needs.

### SUMMARY OF THE INVENTION

In view of the foregoing disadvantages inherent in the known types of edible wrapping paper now present in the prior art, the present invention provides a new wrapping paper and gift box system as well as a method of making the edible paper, wherein the same can be utilized for providing convenience for the user when giving gifts to a pet.

The gift-wrap system includes a molded, hard container formed from either a rawhide composition or a rigid edible paper containing meat products, and at least one piece of flexible wrapping paper flavored with meat products. Edible inks may be used to print patterns or designs on the container and the paper. The components of the system may be used in a variety of ways. For instance, the gift may be placed in the container, which is then wrapped with the paper. Alternatively, the paper may be placed within the container as a buffer between container walls and the gift item.

It is therefore an object of the present invention to provide a new and improved edible gift-wrap system for pets that has all of the advantages of the prior art and none of the disadvantages.

It is an object of the present invention to provide an edible container for retaining pet gifts and a corresponding edible wrapping paper.

Another object of the present invention is to provide a decorative means for wrapping pet gifts that can be safely opened by the pet.

Yet another object of the present invention is to provide an edible treat for pets that has varying textures and tastes.

Still another object of the present invention is to provide an edible treat for pets that stimulates the pet by presenting a puzzle that the pet must solve to obtain their gift.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a perspective view of the gift-wrap system with the container opened and the wrapping paper unwrapped.

FIG. 2 shows a perspective view of the edible paper gift box with a box on top. The box is unwrapped for purposes of showing an exemplary embodiment.

FIG. 3 shows a perspective view of the edible paper gift-wrap wrapped around a gift.

### DETAILED DESCRIPTION OF THE INVENTION

Reference is made herein to the attached drawings. Like reference numerals are used throughout the drawings to depict like or similar elements of the edible gift-wrap for pets. For the purposes of presenting a brief and clear description of the present invention, the preferred embodiment will be discussed as being used for the purposes of providing an edible décor for pet gifts. The figures are intended for representative purposes only and should not be considered to be limiting in any respect.

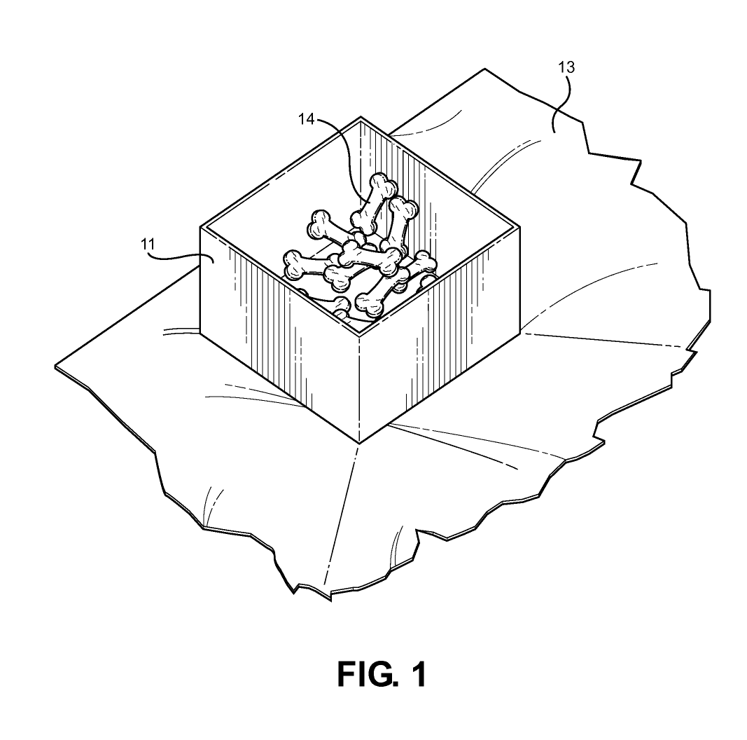

Referring now to FIG. 1, there is shown an exemplary implementation of the gift-wrap system. The system provides a versatile and easy to use gift-wrap that is safe for consumption by most animals. A gift box 11 constructed of the edible paper product is included and may come with a lid 12. A sheet of wrapping paper 13 is included for wrapping the gift box. Alternatively, the wrapping paper may be used in a tissue paper style, as a cushion and protective barrier for items inside the box. A variety of pet gifts can be wrapped using the present system. In the figures, the box is filled with a number of dog treats 14. Noise making toys, stuffed animals, fake bones and other such pet toys are also contemplated for use with the wrapping system. Gift items should be selected by the pet owner according to the interests, health and safety needs of the pet. Once an item is selected, it is placed within the gift box and wrapped within the paper. The wrapped package is given to the pet, who must then determine how to chew through the box and paper to reach the gift inside. In this way, the invention provides both mental and physical stimulation to the pet as it attempts to reach the treat contained therein.

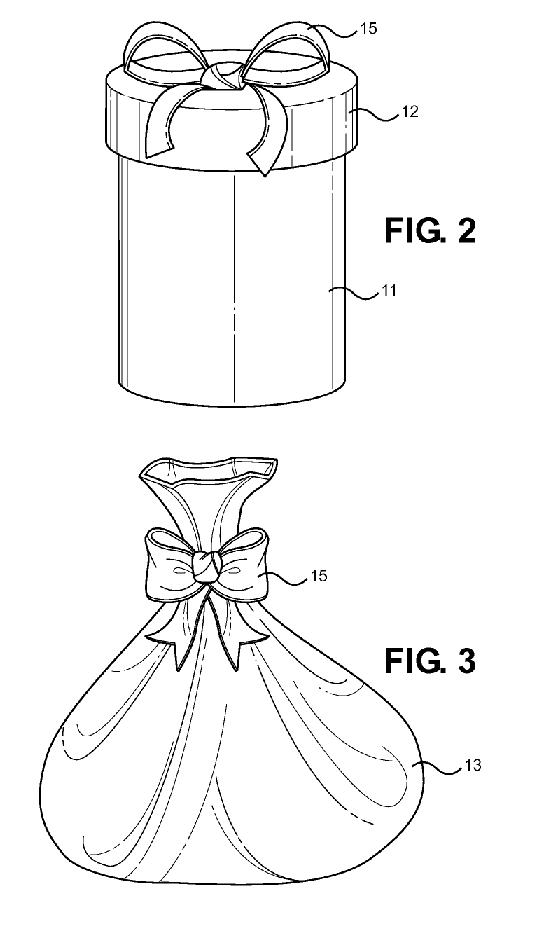

Referring now to FIG. 2, there is shown an edible gift box 11 with a bow 15 used for decoration. The box may be composed of the same materials as the wrapping paper, with the variation that it be a thicker weight of paper or that the composition is baked. If the edible paper composition is thicker during paper making, then a heavy weight, cardstock style of paper will be produced. This heavy weight paper can be cut and folded into a box. Alternatively, the edible paper composition may be poured over a mold and baked. The precise method of constructing the gift box will vary according to the ingredients used and the composition of the edible paper. Paper compositions that are primarily vegetative with a binding agent can easily be made into a heavy weight paper, but paper compositions containing large amounts of dried meat or rawhide may require baking to form a hardened box shell. Baking will involve the creation of an oven-safe mold in the desired box shape. Silicon and aluminum are ideally suited for the box forming process, but other oven-safe materials may be employed so long as they do not release toxins when heated. A lid may be created in a similar manner.

The figure shows a cylindrical box with accompanying lid. Any geometric shape may be used, and there is no need to limit the size and shape of the box to those displayed herein. The great differences in sizes of pets necessitates variety in the structure of the gift box. For example, smaller dogs may find it difficult to chew on a cylindrical box, thus a small square box might be better suited to the small dog's needs.

The second portion of the system is shown in FIG. 3, where a package wrapped in the edible wrapping paper 13 is tied up with a bow 15. Edible wrapping paper may be used to wrap an item prior to placement in the gift box, or may be used to wrap the box itself after a pet gift is placed therein. Unlike the box, the wrapping paper should be as thin and flexible as possible. The inclusion of meat products and vegetable products into the paper will likely result in a thicker and less flexible paper when compared to standard wrapping paper. In one embodiment, a safe, non-toxic, edible adhesive may be coated along the edges of the wrapping paper on one or both sides. Adhesive will be water activated so that a pet owner may moisten the paper slightly along the adhesive portions, and then stick and seal portions of the paper together. In this way, pet gifts can be fully wrapped without the use of inedible tapes. Alternatively, décor items such as string and bows may be used to tie the wrapping paper together, and then removed as the pet begins to chew on the gift.

The pet wrapping paper and gift box may be made from many elements. A variety of papers, such as rice paper, mulberry bark paper, wafer paper and the like may be used in the construction of the wrapping paper. Frosting sheets may also be used so long as the plastic backing is removed. Using frosting sheets can create a tasty, sweet treat that wraps around the stiffer paper box, which may have a meatier flavor. The flavor and type of gift-wrap paper may be different from the paper used for the underlying box to create a variety of flavor and texture combinations.

Several methods of making the edible paper may be employed, however, an exemplary method is described herein. First, a collection of pre-existing organic edible papers is selected. This may include any combination of rice paper, wafer paper, frosting sheets, mulberry paper and other edible papers. These papers are ground into a fine pulp for use as a base. Next, the flavor ingredients are selected, such as dried mats, rawhide, dried carrots, dried blueberries, dried sweet potato, grains, seeds, honey, herbal extracts and the like. These ingredients are pulverized and combined with the collection of paper pulp. Liquid starch is then added to and mixed thoroughly to create a moistened paper mixture. Next, a porous mold is prepared in the shape of the wrapping paper sheet or gift box. The mold is submerged in the mixture and gently shaken from side to side to level out the coating of the mixture. Once the mixture is level within the mold, the mold is lifted up above the mixture. Because the mixture in the mold was submerged, it will drip for a period of time after being removed from the mixture. Once the mixture is done dripping, a sponge is applied to the surface of the mixture to soak up additional water. Fabric is then placed over the mixture in the mold, and the mold is inverted to remove the paper from the mold. Dry heat is applied to the mixture to finish the drying process. In this way, a versatile edible paper is made for use with the present system.

To the extent possible, all-natural ingredients should be used to minimize the potential for digestive distress in pets that consume the paper. Exact composition of the paper will depend upon the intended recipient. For example, rabbit pets will not be able to process papers containing meat products, therefore a combination of dried, ground vegetables and seeds or grains are best suited for construction of wrapping paper and boxes for rabbits. All-natural flavoring, such as thistle oil or carrot juice may be used to give the paper a smell and taste that will attract the pet. Cats and dogs, on the other hand, can process both meat and vegetables but prefer meat products. Thus, dried, ground meat may be added to the paper in large quantities. Honey, mint, fish oils, spices, and others may be included in the paper to provide a stronger taste or smell.

The gift box will be created from the same set of materials as the wrapping paper with the further inclusion of rawhide or starchier ingredients. Wrapping paper will not require baking during the paper creation process, however, the gift box may require that it be wrapped around a mold or formed to fit a mold and then baked. Alternatively, additional rice or mulberry can be used to create a strong stiff cardboard or card stock style of paper that can be folded into a box of any shape and size.

Edible inks are used to print attractive patterns or pictures on the gift box and/or wrapping paper. Owners may personalize the images or select preprinted wrapping paper patterns. Holiday themes and special occasions are common patterns for gift paper, and can easily be printed on the paper and or the box. Food colorings from both natural and synthetic dyes may be used so long as they are safe and non-toxic for consumption by pets.

In use, an individual selects a gift to give their pet, such as an edible treat, a stuffed toy, a squeaky toy, or the like. The pet owner then selects an appropriately sized gift box made of a material that is appropriate for the intended recipient. The box may come with wrapping paper, or alternatively, a variety of corresponding wrapping papers may be displayed near the box so the pet owner can choose the paper himself. For instance, if a dog box of a particular size is selected, there may be several wrapping papers with preprinted designs that are marked as “for dogs.” The pet owner then decides whether to use the wrapping paper on the outside or the inside of the box. This is up to the owner and may depend on the nature of the gift. The owner then wraps the gift in the gift box and wrapping paper and gives it to the pet. Pets should not be left unattended with the gift because owners will need to make certain that the wrapping system components are consumed in a safe manner.

The present invention is a gift-wrap system that is safe for consumption by pets of different species, breed, and size. The system provides an edible gift box and wrapping paper that are used to wrap a pet toy, treat, or the like. If the system is sold together as a wrapping kit, then the flavor of the components may be similar along with the depicted patterns. The components may also be sold separately as matched elements of a set. Thus, when a user selects a box it will have indicia on the packaging that provides information about the set. In an exemplary implementation, boxes can be marked with the number one, and all boxes that are intended for consumption by dogs will be marked as such. Lids will be marked with the number two, and wrapping paper marked with the number three. Any décor items, such as bows will be marked with indicia also. In this way, a pet owner can easily select an appropriate gift-wrap set for their pet by selecting any number one, number two, and number three that is marked for dogs. Flavors and patterns will vary to provide users with choices in their selections, and to accommodate the varied tastes of the pet recipients. The system thus provides pet owners with a safe, non-toxic means for giving wrapped gifts to pets.

To this point, the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) An edible pet wrapping paper and gift-wrap system with interchangeable parts comprising:
a gift box made from a heavy weight edible paper; and
a sheet of gift-wrap made from a lightweight edible paper.

2) The system of claim 1, further comprising:
a lid composed of an edible paper and engaging with said gift box.

3) The system of claim 1, further comprising:
a bow made of edible paper.

4) The system of claim 1, wherein said wrapping paper has an edible adhesive coating around a perimeter of at least one side of said wrapping paper.

5) The system of claim 1, wherein said gift box and said wrapping paper are made from edible papers having different flavors.

6) The system of claim 1, wherein said heavy weight edible paper contains rawhide.

7) The system of claim 1, wherein said lightweight edible paper contains dried meat.

8) A method of creating an edible gift paper comprising the steps of:
selecting a plurality of edible paper pieces;
grinding said paper pieces into a paper pulp;
selecting a plurality of flavor additives;
grinding said flavor additives into a fine mixture;
combining said paper pulp and said mixture of flavor additives and a liquid starch;
mixing said paper pulp, said flavor additives and said liquid starch to form an edible paper mixture;
placing a porous mold into said edible paper mixture and gently shaking said mold until said edible paper mixture is level within said porous mold;
lifting said porous mold from said edible paper mixture and allowing the mixture to drip excess moisture;
after said edible paper mixture has finished dipping, blotting said edible paper mixture contained within said porous mold with a sponge;
placing fabric over said edible paper mixture in said porous mold and inverting said porous mold; and
applying dry heat to said edible paper mixture on said fabric until said edible paper mixture is dry.

9) The method of claim 8, wherein said flavor additives comprise dried meat.

10) The method of claim 8 wherein said flavor additives comprise rawhide.
